(19) United States
(12) Patent Application Publication
(10) Pub. No.: US 2025/0042141 A1
(43) Pub. Date: Feb. 6, 2025

(54) ALL-PE RECYCLABLE LAMINATE WITH NANOCLAY COATING

(71) Applicant: NOVA Chemicals (International) S.A., Fribourg (CH)

(72) Inventor: Robert Clare, Cochrane (CA)

(73) Assignee: NOVA Chemicals (International) S.A., Fribourg (CH)

(21) Appl. No.: 18/714,748

(22) PCT Filed: Nov. 25, 2022
(86) PCT No.: PCT/IB2022/061438

§ 371 Date: May 30, 2024

Related U.S. Application Data
(60) Provisional application No. 63/288,848, filed on Dec. 13, 2021.

(51) Int. Cl. B32B 27/08; B32B 27/32

(52) U.S. Cl. CPC B32B 27/08; B32B 27/32; B32B 2250/02; B32B 2250/242; B32B 2255/10; B32B 2255/20; B32B 2272/00; B32B 2307/518; B32B 2307/538; B32B 2307/718; B32B 2307/72; B32B 2307/7376

(57) ABSTRACT

Provided herein is a laminate comprising first and second film layers prepared primarily, if not entirely, using polyethylene resins. The first film possesses a low level of surface roughness and a continuous coating, comprising an aqueous dispersion of a clay mineral, that becomes contained at the interface between the first and second film layers following lamination. The laminate is suitable for use in packaging applications that require optimal oxygen barrier performance, and since the laminate is prepared primarily from polyethylene it is accompanied by the benefit of being amenable to recycling.

### TECHNICAL FIELD

The present invention relates to an oriented all-PE recyclable film with premium oxygen barrier properties having good tensile strength, clarity, stiffness, and abuse resistance.

### BACKGROUND ART

Plastics are widely used for the packaging of foods and non-food items that need to be protected from water vapor and oxygen. Although there are some plastics that can provide water vapor barrier, the ability to block oxygen and other gases is more challenging. The challenge increases when considering the design of packaging that is amenable to recycling. For all polyethylene (all-PE) films and laminates there is a tradeoff between having good oxygen/gas barrier, cost, and suitability for recycling.

One common method of gaining oxygen transmission barrier in coextruded flexible all-PE films and laminates that may be recycled is to incorporate a thin layer of a non-PE material layer such as ethylene vinyl alcohol (EVOH), a copolymer of ethylene and vinyl alcohol. Unfortunately, when used, EVOH is usually included at a thickness of 4-7 microns, which negatively impacts the quality when recycled. This is due to a lack of homogeneity between the EVOH and the polyethylene. Use of compatibilizers may improve homogeneity but they are costly and require extra blending equipment during film production. Furthermore, using EVOH and a compatibilizer may not be possible for suppliers lacking the extrusion equipment for preparation of complex film structures comprising at least 5 layers.

Other approaches for gaining high oxygen barriers in all-PE structures include use of metallization or oxide coatings. However, these approaches are generally unacceptable for recycling, costly, or fail to provide desired clarity for packaging applications that require a window for viewing the contained products. What is needed is an option for providing a thin, clear oxygen barrier for all-PE films that is inexpensive and doesn't negatively impact recyclability.

### SUMMARY OF INVENTION

Provided in this disclosure is a laminate comprising a continuous coating at the interface of a first film and a second film. The continuous coating comprises a clay mineral aqueous dispersion that is applied to the first film, the first film having a surface roughness, Rsa, of less than 0.070 microns. In some embodiments, both the first and second films are made primarily, if not entirely, from polyethylene, which renders the laminate amenable to recycling. Directionally oriented films, including machine and biaxially oriented films, are suitable for use in preparation of one or both of the first and second film.

### DESCRIPTION OF EMBODIMENTS

Provided herein is a laminate comprising a first film layer having a low level of surface roughness and a substantially continuous coating laminated to a second film. The coating, comprising an aqueous dispersion of clay mineral, is contained at the interface between the first film and the second film. The resins used in preparation of the film described herein are primarily, if not entirely, polyethylene, making the laminate more amenable to recycling. The laminate provides an opportunity for packaging applications that require optimal oxygen barrier performance but are also amenable to recycling. Furthermore, a user may select additional polymers to provide a laminate that not only has optimal oxygen barrier performance, but is also tailor made for ideal moisture barrier, abuse resistance, stiffness, and heat resistance properties.

Other than in the operating examples or where otherwise indicated, all numbers or expressions referring to quantities of ingredients, reaction conditions, etc. used in the specification and claims are to be understood as modified in all instances by the term “about”. Accordingly, unless indicated to the contrary, the numerical parameters set forth in the following specification and attached claims are approximations that can vary depending upon the desired properties, which the present disclosure desires to obtain. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical values, however, inherently contain certain errors necessarily resulting from the standard deviation found in their respective testing measurements.

In addition, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

### Definitions

As used herein, the terms “polyethylene”, “polyethylene composition”, or “ethylene polymer”, refers to macromolecules produced from ethylene monomers and optionally one or more additional monomers, regardless of the specific catalyst or specific process used to make the ethylene polymer. In the polyethylene art, the one or more additional monomers are often called “comonomer(s)” and typically include α-olefins. The term “homopolymer” generally refers to a polymer that contains only the ethylene monomer. The term “copolymer” refers to a polymer that contains ethylene and one or more comonomers. Common polyethylene types include polyethylene homopolymer composition (HDPE); medium density polyethylene (MDPE); linear low density polyethylene (LLDPE); and very low density polyethylene (VLPDE) or ultralow density polyethylene (ULPDE) which are also known as plastomers and elastomers. The term polyethylene also includes polyethylene terpolymers which may include two or more comonomers in addition to ethylene. The term polyethylene also includes combination of, or blends of, the polyethylene types described above.

As used herein, the “film” refers to a film having one or more layers which is formed by the extrusion of a polymer through one or more die openings. The term “film structure” is used to connote that a film has more than one layer (i.e. a film structure may have at least two layers, at least three layers, at least four layers, at least five layers, at least six layers, at least seven layers, at least eight layers, at least nine layers, etc.). Formation of layers in a film structure may be the result of co-extrusion, lamination, or a combination of both.

As used herein, the terms “polyethylene film” or “all-PE film” refers to films or a film structure that is composed primarily, if not entirely, of polyethylene. Films of this type will comprise at least 90 percent by weight of a polyethylene (as opposed to non-polyethylene based polymeric materials or compositions), based on the total weight of polymer present in the film or film structure.

As used herein, the term “skin layer” refers to an exterior layer of a multilayer film structure (i.e. a layer having an external surface exposed to the environment).

As used herein, the term “core layer” refers to an interior layer of a multilayer film structure (i.e. a layer that is not exposed to the environment and is adjacent on both sides to an inner surface of a skin layer or to another interior or core layer). A multilayer film structure may have one or more core layers which may also be deemed adjacent interior layers.

As used herein, the term “substantially continuous” refers to the coating covering the entirety of the surface.

### Part 1—Clay Coatings

Use of clay coatings to improve oxygen barrier performance in plastic films is known. Particularly, films made from polyethylene terephthalate (PET) and polypropylene (PP) have been used with considerable commercial success as the “substrates” for clay coated films that provide good oxygen barrier. In contrast, attempts to produce clay coated polyethylene films have not been associated with any degree of commercial success, primarily due to inability of the clay coating to form a barrier on the raw surface. Addition of a primer prior to application of the clay coating may provide barrier coating performance enhancement but is time consuming and expensive.

Without wishing to be bound by theory, that coating polyethylene with clay minerals has been unsuccessful may be due to the surface roughness of polyethylene. Higher surface roughness would result in dips and peaks that prevent clay platelets to form a complete barrier. Substrates with a smoother surface with lower dips and lower peaks are better suited for applying a coating that forms a barrier that would need to cover substantially the majority of the surface so as to create a tortuous path to restrict oxygen molecules transmission. This position is supported by the fact that materials such as biaxially oriented PP and polyester, known to act as a substrate for clay coatings, has much lower surface roughness than either blown or cast extrusion polyethylene films typically used in film and laminate applications.

We have discovered that clay coatings can be applied successfully to polyethylenes that have a surface roughness that is comparable to, or even lower, than the surface roughness for known clay coating substrates. Application of a coating to plastic films falls within the scope of knowledge of the skilled person. Known clay coatings, or clay minerals, used in film applications include, but are not limited to, vermiculite and montmorillonite, which are typically supplied as a suspension in polyvinyl alcohol (PVOH) which can be gravure coated onto the film surface which is then dried to evaporate the water content, leaving a matrix of the clay and PVOH on the surface.

To provide substantial coverage the coating of clay mineral must cover the surface fully and consistently. To accomplish this the coat weight, in grams of clay mineral per square meter of the film, should ideally exceed 0.1 g/m² of the film surface. The skilled worker would appreciate that these values represent the dry weight of clay mineral after application and drying. In some embodiments the coating has a coat weight of from 0.1 to 0.8 g/m² of the film surface. In some embodiments the coating has a coat weight of from 0.2 to 0.6 g/m² of the film surface. In some embodiments the coating has a coat weight of from 0.3 to 0.5 g/m² of the film surface.

The thickness of the coating having coat weights described above typically may fall between 0.10 and 1.00 microns, or from 0.15 to 0.60 microns, or most likely from 0.20 to 0.40 microns.

### Part 2—The First Film

As mentioned above the application of the coating to a polyethylene requires a smooth surface to allow the clay platelets to spread out and form a tortuous route for oxygen. While it is possible that some polyethylenes when formed into a film may possess a lower surface roughness than other polyethylenes it is unlikely that these will provide commercially relevant substrates for the application of clay coatings. Ideally, the first film is directionally oriented, either by machine direction or biaxially. The orientation processes, known by the skilled worker, can reduce the surface roughness substantially. In an embodiment the first film has a surface roughness that is comparable to a typical oriented polypropylene or polyester film structure. In an embodiment the first film has a surface roughness that is less than 0.070 microns when measured by confocal microscopy. In an embodiment the first film has a surface roughness that is less than 0.060 microns when measured by confocal microscopy. In an embodiment the first film has a surface roughness that is less than 0.055 microns when measured by confocal microscopy. For ideal results the surface roughness should be low as possible. Clearly, the surface roughness cannot reach 0, but values as low as 0.01 microns are not out of the realm of possibility.

In some embodiments, the first film may comprise one or more of low density polyethylene, linear low density polyethylene, medium density polyethylene, and high density polyethylene.

In some embodiments, the first film may comprise a blend of one or more of low density polyethylene, linear low density polyethylene, medium density polyethylene, and high density polyethylene.

In some embodiments, the first film may comprise a film structure of two or more co-extruded layers, each layer comprising one or more of low density polyethylene, linear low density polyethylene, medium density polyethylene, and high density polyethylene.

In some embodiments, the first film may comprise a film structure of two or more layers laminated to each other, each layer comprising one or more of low density polyethylene, linear low density polyethylene, medium density polyethylene, and high density polyethylene.

The method of production of the polyethylene used is not limiting. The one or more polyethylenes may be formed in a gas phase, solution, or high pressure process. The one or more polyethylenes may be formed using any catalyst known in the art, including, but not limited to, Ziegler-Natta and single site catalysts.

In some embodiments, the first film comprises a high density polyethylene have a density of from 0.940 to 0.970 g/cm³. Including a high density polyethylene in the first film proves high heat resistance in the coating and drying process.

In another embodiment, the first film comprises a film structure with two layers, a first layer comprising at least 80 wt. % of the first film and having a density of from 0.940 to 0.970 g/cm³, and a second layer comprising a linear low density polyethylene having a density of from 0.910 to 0.940 g/cm³ wherein the coating is applied to the linear low density polyethylene side of the film structure. This design promotes formation of very low surface roughness when the film structure is subjected to directional orientation.

### Part 3—The Second Film

The second film is laminated to the first film so as to contain the coating at the interface between the two films. Processes for lamination are well known in the art and suitable for use with the subject matter described herein.

In some embodiments, the second film is directionally oriented.

In some embodiments, the second film is biaxially oriented.

In some embodiments, the second film is machine direction oriented.

In some embodiments, the second film may comprise one or more of low density polyethylene, linear low density polyethylene, medium density polyethylene, and high density polyethylene.

In some embodiments, the second film may comprise a blend of one or more of low density polyethylene, linear low density polyethylene, medium density polyethylene, and high density polyethylene.

In some embodiments, the second film may comprise a film structure of two or more co-extruded layers, each layer comprising one or more of low density polyethylene, linear low density polyethylene, medium density polyethylene, and high density polyethylene.

In some embodiments, the second film may comprise a film structure of two or more layers laminated to each other, each layer comprising one or more of low density polyethylene, linear low density polyethylene, medium density polyethylene, high density polyethylene, and blends thereof.

The method of production of the polyethylenes used is not limiting. The one or more polyethylenes may be formed in a gas phase, solution, or high pressure process. The one or more polyethylenes may be formed using any catalyst known in the art, including, but not limited to, Ziegler-Natta and single site catalysts.

### Part 4—The Laminate

The laminate described herein is produced by preparation of the first and second films and laminating them together. The lamination process falls within the scope of knowledge possessed by the person skilled in the art. In some embodiments, the method of lamination may include applying a wet adhesive to the first or second film and then pressing the films between rollers, where the wet adhesive, or glue, may be water or solvent based. The use of water or solvent based glues usually requires drying off the carrier liquid with heat. Use of solventless glues is also contemplated for use with the laminate described herein, such as a 2 part polyurethane adhesive. In some embodiments, the method of lamination may include thermal lamination or extrusion lamination, methods of which fall with the scope of knowledge possessed by the person skilled in the art.

In some embodiments, a printed laminate may be formed where the first film is prepared by application of a print, applied as a wet coating, to the clay coating prior to lamination of the first film to the second film.

The overall thickness of the laminate may depend on the application for which the laminate is to be used. In some embodiments the laminate the thickness may be from 0.50 to 20.0 mils. In some embodiments the laminate the thickness may be from 0.50 to 14.0 mils. In some embodiments the laminate the thickness may be from 0.50 to 8.0 mils. In some embodiments the laminate the thickness may be from 0.50 to 5.0 mils. In some embodiments the laminate the thickness may be from 0.50 to 3.0 mils.

### EXAMPLES

A comparison between films formed from a variety of resins was performed to assess the relative surface roughness, with results shown in Table 1. Surface roughness measurements were performed using confocal microscopy. The resins were chosen to compare the surface roughness of resins known as suitable substrates for application of clay barrier coatings relative to the surface roughness of different polyethylene resins commonly used in film and laminate applications. The Rsa values are a representative average of 3 or more measurements.

TABLE 1

| | Density | | Rsa |
|---|---|---|---|
| Resin | (g/cm³) | Orientation | (avg) |
| Polyester | 1.14 | Biaxial | 0.063 |
| Polypropylene | 0.925 | Biaxial | 0.057 |
| LLDPE (glossy) | 0.916 | Blown | 0.184 |
| MDPE | 0.934 | Blown | 0.115 |
| MDPE | 0.934 | Machine direction | 0.048 |
| MDPE (high gloss) | 0.935 | Blown | 0.046 |
| MDPE | 0.935 | Machine direction | 0.043 |
| HDPE | 0.957 | Machine direction | 0.040 |

These results demonstrate that resins known for suitability as substrates for clay barrier coatings have lower surface roughness than blown polyethylene films. Furthermore, the directionally orienting polyethylene films results in a significant drop in the surface roughness.

Polyethylene laminates and films were prepared to demonstrate the effect of addition of the clay coating on the oxygen transmission rate (OTR), expressed as cubic centimeters of oxygen per 100 square inches of film per day at a specified film thickness (mils) (cc/100 in²/day) and measured using an instrument sold under the brand name MOCON OXTRA System, model 2/21T, shown in Table 2 below. All measurements were performed at 23° C. and the relative humidity (RH) was varied to demonstrate the effect of moisture on the oxygen barrier capacity. Films measuring an OTR below 1.000 cc/100 in²/day are considered to have excellent oxygen barrier properties. For comparison, high density polyethylene films having a thickness of 1 mil typically have an OTR greater than 30 cc/100 in²/day.

TABLE 2
Barrier Results

| | | | | RH | OTR |
|---|---|---|---|---|---|
| Ex. | Structure | Conditions | Orientation | (%) | (cc/100 in²/day) |
| 1 | Laminate | Sealant exposed to | Biaxial | 90 | 0.122 |
| | | humidity | | | |
| 2 | Laminate | Sealant exposed to | Biaxial | 90 | 0.535 |
| | | humidity for 23 hours | | | |
| 3 | Laminate | No humidity control | Machine direction | 0 | 0.020 |
| 4 | Laminate | Typical humidity | Machine direction | 50 | 0.021 |
| 5 | Film | No humidity control | Machine direction | 0 | 0.425 |
| 6 | Film | No humidity control | Machine direction | 0 | 0.345 |

The clay coatings described herein are known to be hygroscopic so inclusion in a laminate that also displays good water vapor transmission barrier properties is recommended to fully utilize the oxygen barrier properties of the clay coating. Examples 1 and 2 were laminates with the first film laminated to the second film that comprised a sealant layer comprising NOVA Chemicals HPs167, which provides excellent moisture barrier, with testing performed with the sealant layer exposed to the humidity test gas, with example 2 measurements recorded for a duration of 263 hours. The results demonstrate that lamination to a layer with good moisture barrier allows for prime oxygen barrier and that even over 263 hours the oxygen barrier protection does not degrade catastrophically.

Examples 3 and 4 were performed without exposing the sealant side to the humidity test gas and demonstrate that the coatings provide excellent oxygen barrier properties at zero humidity and when humidity approaches typical conditions.

Finally, examples 5 and 6 represented a first film that was not laminated to a second film and also demonstrate very good oxygen barrier properties, having OTR values that are well below 1.000 cc/100 in²/day.

While the examples all include an HDPE film as the first film, it is expected that lower density polyethylenes (e.g. MDPE, LDPE, and LLDPE), or blends of polyethylenes with different densities, may also be suitable provided the surface roughness of the film or film structure fits within the limitations described herein.

### INDUSTRIAL APPLICABILITY

The present disclosure relates to a laminate film comprising two films and a nanoclay interface. The described films display premium oxygen barrier properties and being composed of primarily of polyethylene they are amenable to recycling.

1. A laminate comprising:
a first film having a surface roughness, Rsa, of less than 0.070 microns;
a continuous coating comprising a clay mineral on the first film; and
a second film;
wherein the first film is laminated to the second film and the coating is contained at the interface between the first film and the second film.

2. The laminate of claim 1 wherein the first film is directionally oriented.

3. The laminate of claim 1 wherein the first film is biaxially oriented.

4. The laminate of claim 1 wherein the first film is machine direction oriented.

5. The laminate of claim 1 wherein the second film is directionally oriented.

6. The laminate of claim 1 wherein the coating has a coat weight of from 0.1 to 0.8 grams per square meter of the first film.

7. The laminate of claim 1 wherein the coating has a coat weight of from 0.2 to 0.6 grams per square meter of the first film.

8. The laminate of claim 1 wherein the coating has a coat weight of from 0.3 to 0.5 grams per square meter of the first film.

9. The laminate of claim 1 wherein the clay mineral is selected from the group consisting of vermiculite and montmorillonite.

10. The laminate of claim 1 wherein the laminate has a thickness of from 0.5 to 3.0 mils.

11. The laminate of claim 1 wherein the first film comprises a surface roughness, Rsa, of less than 0.060 microns.

12. The laminate of claim 1 wherein the first film comprises a surface roughness, Rsa, of less than 0.055 microns.

13. The laminate of claim 1 wherein the first film comprises at least 80 wt. % of a high-density polyethylene having a density of from 0.940 g/cm³ to 0.970 g/cm³ as measured by ASTM D792-13.

14. The laminate of claim 1 wherein one or both of the first film and the second film comprise a co-extruded film structure.

15. The laminate of claim 1 wherein the first film is a film structure comprising:
a first layer comprising a high density polyethylene having a density of from 0.940 g/cm³ to 0.970 g/cm³ as measured by ASTM D-792-13; and
a second layer comprising a linear low density polyethylene having a density of from 0.910 to 0.940 g/cm³ as measured by ASTM D-792-13;
wherein the first layer is at least 80 wt. % of the first film and the coating covers the second layer.

16. The laminate of claim 14 wherein the first film has a surface roughness, RSa, of less than 0.050 microns.

17. The laminate of claim 1 wherein one or both of the first film and the second film comprise one or more of low density polyethylene, linear low density polyethylene, medium density polyethylene, and high density polyethylene.

18. The laminate of claim 1 wherein one or both of the first film and the second film comprise one or more of low density polyethylene, linear low density polyethylene, medium density polyethylene, and high density polyethylene.

19. The laminate of claim 1 wherein one or both of the first film and the second film comprise a blend of one or more of low density polyethylene, linear low density polyethylene, medium density polyethylene, and high density polyethylene.

20. The laminate of claim 1 wherein one or both of the first film and the second film comprise a film structure of two or more co-extruded layers, each layer comprising one or more of low density polyethylene, linear low density polyethylene, medium density polyethylene, and high density polyethylene.
